(19) United States
(12) Patent Application Publication
(10) Pub. No.: US 2026/0192214 A1
(43) Pub. Date: Jul. 9, 2026

(54) APPARATUS AND METHOD FOR TREATING A FLOW OF A SUBSTANCE TO BE TREATED BY MEANS OF A COUNTERFLOW OF AN EXTRACTING SUBSTANCE

(71) Applicant: BOB SERVICE SRL, Torino (IT)

(72) Inventor: Giuliano CAVAGLIA', Chieri (TO) (IT)

(21) Appl. No.: 18/868,764

(22) PCT Filed: Jun. 8, 2023
(86) PCT No.: PCT/IB2023/055917

§ 371 Date: Nov. 24, 2024

(30) Foreign Application Priority Data
Jun. 9, 2022 (IT) 102022000012218

(51) Int. Cl. B01D 11/02

(52) U.S. Cl. CPC B01D 11/0226; B01D 11/0261

(57) ABSTRACT

Apparatus is provided for treating a flow of a substance to be treated by means of a counterflow of an extracting substance. The apparatus has a motor-driven treatment assembly in which flows pass in substantially opposite directions and in which there are defined at least one first fixed member and at least one corresponding first movable member rotary relative to the fixed member and cooperating therewith to define a corresponding cavitation stage capable of causing the phenomenon of hydrodynamic cavitation in a mixture of the substances. The at least one fixed member and/or the at least one movable member is provided with a plurality of radial protrusions, at least one of which is configured so as to cause, during rotation of the movable member, a propelling effect over the flow of substance to be treated, in a direction substantially opposite to the counterflow of extracting substance.

The invention relates to an apparatus and a method for treating a flow of substance to be treated by means of a counterflow of an extracting substance.

### TECHNICAL FIELD

The invention pertains to the field of the technologies used to enhance phase contact and hence matter and heat transport, and to enhance chemical reaction kinetics.

The apparatus according to the invention finds advantageous applications in several industrial sectors, for example as extractor of high-quality functional foods, starting from vegetable substances and natural products.

A particular though not exclusive application of the invention relates to the extraction of functional foods starting from vegetable matrices either solid or in powder form or crushed in pieces of various sizes, such as, for example, malt spent grains deriving from the production of beer, or from waste sludge from food industry processing, for example containing orange peels.

### PRIOR ART

WO2018/146647 discloses an apparatus for enhancing phase contact between one or more liquid phase(s) and a solid phase, comprising high-turbulence sections alternating with sections of hydrodynamic cavitation with high shear force, wherein a first flow of a first substance in solid phase can travel either in in equicurrent or countercurrent relative to a second flow of a second substance in liquid phase.

According to a particular embodiment of the teaching proposed therein, in the event that it is advantageous to cause countercurrent contact between the phases, such as in unitary operations of stripping, extraction, leaching, etc., the phases can be fed in opposite directions.

In a particular embodiment thereof, the apparatus disclosed in the mentioned prior art, allows treating a flow of substance to be treated by means of a counterflow of an extracting substance. In the configuration provided to this purpose, the known apparatus comprises a motor-driven treatment assembly, in which said flows pass in substantially opposite directions and along substantially parallel directions.

In the known apparatus, there are provided a first fixed member and at least one corresponding member rotary relative to the fixed member and cooperating therewith to define cavitation stages capable of causing the phenomenon of hydrodynamic cavitation in a mixture of said substances passing in opposite directions in the apparatus and stages of turbulent mixing, alternating with cavitation stages.

In the known apparatus, there is provided a first fixed member and at least one corresponding member rotary relative to the fixed member and cooperating therewith to define a corresponding cavitation stage, capable of causing the phenomenon of hydrodynamic cavitation in a mixture of said substances passing in opposite directions within the apparatus. The cavitation stages are further alternated with stages of turbulent mixing.

One of the drawbacks encountered in the teaching provided by the mentioned prior art derives from the poor performance of the apparatus when it works in countercurrent.

The Applicant has observed that in an apparatus of the type described in WO2018/146647 there is a countercurrent flow of the solid phase of a substance to be treated, relative to the liquid phase of an extracting substance, thanks to the gradient of solid-phase concentration that is formed along the axis of the apparatus, wherein the gradient decreases from the apparatus end from which the solid phase is fed to the apparatus end from which the liquid phase is fed, which is also the apparatus end from which the spent solid phase exits following extraction.

The Applicant has further observed that, by working with the following ratios:

L/S>40
where
L=liquid phase mass flow rate and
S=solid phase mass flow rate,
a condition of stable flow of solid phase is obtained, in the presence of a counterflow of liquid phase.

Upon decrease of the L/S ratio, an increase of criticality in maintaining the condition of stable flow of the solid phase is observed. Upon reaching an L/S ratio of about 30, a point of impossibility of stable countercurrent operation is reached, this resulting in the blockage of the operation of the apparatus due to the accumulation of the solid phase in the first chamber of turbulent mixing, i.e., typically the mixing chamber to which the solid phase is fed.

As is known, the L/S ratio is a parameter of paramount importance in industrial operations of solid-liquid extraction, because the higher the L/S ratio, the higher the flow rate of liquid, containing the extracted solute, to be subjected to the subsequent operations of separation, purification, concentration and drying, for the same quantity of end product obtained. This means that the higher the L/S ratio of the operation of solid-liquid extraction, the higher the investment cost for the separation, purification, concentration and drying section and the operating cost thereof.

For the investment and operating costs of a solid-liquid extraction installation to be economically competitive, the solid-liquid extraction section must be operated in the presence of the lowest possible L/S ratio, preferably L/S<10 and, even more preferably, L/S<5.

A main object of the present invention is therefore to provide a solution to the aforementioned problem of how to optimize the performance of an apparatus for enhancing phase contact, when the substance to be treated travels in countercurrent relative to a flow of an extracting substance.

Another object of the invention is to provide an apparatus and a method for treating a flow of substance to be treated by means of counterflow of an extracting substance, which are more efficient relative to prior art and allow reduced operating costs.

Not least object of the invention is to provide an apparatus and a method of the type mentioned above that is industrially applicable on a large scale.

These and other objects are achieved with the apparatus and method as claimed in the appended claims, which form an integral part of the technical teaching provided in the present description in respect of the invention.

### DISCLOSURE OF THE INVENTION

The apparatus according to the invention makes it possible to treat a flow of a substance to be treated by means of a counterflow of an extracting substance.

According to the invention, the substance to be treated and the extracting substance may take physical states different from each other, for example, the solid state and the liquid state, respectively.

The flow of substance to be treated may include, for example, a mass of material in the solid state, typically in the form of powder, crushed pieces, sludge, granules and flakes, in which components advantageous to be extracted, for example, polyphenols, proteins, dietary fibers and essential oils, are dispersed. The flow of extracting substance may consist of a substance in the liquid state, typically water.

Advantageously, the apparatus according to the invention is capable of causing an increase in the relative sliding speeds of the phases involved in a multiphase flow passing through the apparatus.

Advantageously, the apparatus according to the invention makes it possible to implement a low-temperature extraction process, preventing the oxidation phenomenon from being triggered, and thus enabling the production of high-quality polyphenols and proteins with high antioxidant power.

Advantageously, the apparatus according to the invention makes it possible to extract the aforementioned components with a higher level of efficiency than prior art and with a yield that is higher than 70% and can be of over 90%.

Advantageously, the apparatus according to the invention makes it possible to implement a process of extracting components, such as polyphenols, proteins, dietary fibers and essential oils, from a substance to be treated, either without or with a reduced use of volatile solvents.

Advantageously, the apparatus according to the invention makes it possible to implement an extraction process of the above-mentioned type that is quicker than currently known processes.

Not least advantage of the apparatus according to the invention derives from the reduced energy consumption compared to currently employed extraction technologies.

In a particular embodiment of the apparatus according to the invention, thanks to the combined action of the high turbulence, the shear force and the phenomenon of cavitation, the components of the substance to be treated are extracted quickly, typically in less than 3 minutes, and brought to the liquid phase.

The apparatus according to the invention mainly comprises a motor-driven treatment assembly in which a flow of a substance to be treated and a counterflow of an extracting substance travel in a countercurrent regimen. More specifically, although within the motor-driven treatment assembly the flows of substance to be treated and extracting substance take various directions, imposed by the movement and shape of the members forming the treatment assembly, said flows pass altogether through the treatment assembly, i.e., from the respective inlet port to the respective outlet port, in substantially parallel but substantially opposite directions.

According to the invention, the motor-driven treatment assembly has at least one fixed member and at least one corresponding movable member, rotary relative to the fixed member and cooperating therewith to define a corresponding cavitation stage capable of causing the phenomenon of hydrodynamic cavitation in a mixture of said substances.

According to the invention, turbulent mixing of said substances is provided upstream and/or downstream of the cavitation stage.

Preferably, the cavitation stage is capable of causing a high shear force and a high cavitation on the mixture of substances. Even more preferably, said stage with high shear force and high cavitation can subject the mixture of substances to a cavitation regimen characterized by a cavitation number σ<1.

According to the invention, advantageously, the movable member and/or the fixed member is provided with a plurality of radial protrusions, or teeth.

Advantageously, according to the invention, the protrusions of the movable and fixed member of the hydrodynamic cavitation stages with high shear force make it possible to establish an optimized countercurrent flow regimen of the solid phase, i.e., of the substance to be treated, with respect to the liquid phase.

In particular, referring to FIG. 1, this schematically shows a preferred configuration of the protrusions of the fixed and movable members, in which said protrusions are rectilinear and inclined relative to the rotation axis S1 of the movable member, which rotates in the direction indicated by arrow R1.

The Applicant has observed that, by inclining the geometry of the protrusions 21a of the fixed members 15 and the geometry of the protrusions 21b of the movable members 17 relative to the rotation axis S1 of the motor-driven treatment assembly, a propelling effect for the solid phase is obtained so as to allow a countercurrent flow of the solid phase with respect to the flow of the liquid phase also in the presence of very low L/S ratios, typically L/S<1.

By propelling effect, it is meant an effect of forward thrust or forward movement.

Any angle of inclination of the protrusions 21a,21b of the fixed or movable members relative to the rotation axis of the movable members, other than α=0° and α=900 is capable of exerting a propelling effect in the direction of advancement F1 of the solid flow of the substance to be treated, in countercurrent with respect to the direction F2 of the liquid flow of the extracting substance.

However, it has been found that:

i. For angles within the range 0°<α<3°, the propelling effect is so important that it is necessary to operate the motor-driven treatment assembly at low rotational speeds, typically <500 rpm to avoid working with a concentration of solid that is not uniform along the rotation axis S1 of the assembly, i.e., to avoid a ratio Cₛₙ/Cₛ₁>3, where:
Cₛ₁=concentration of solid phase in the turbulent mixing chamber to which the solid phase is fed, and
Cₛₙ=concentration of solid phase in the turbulent mixing chamber upon exit of the solid phase itself.

With such rotational speed regimen, however, the intensities of turbulence, shear force and cavitation are penalized.

ii. For angles within the range 80°<α<90°, the propelling effect is limited, to the extent that it is necessary to operate the treatment assembly at high rotational speeds, typically >3000 rpm to avoid working with a concentration of solid that is not uniform along the rotation axis S1 of the assembly, i.e., to avoid a ratio Cₛ₁/Cₛₙ>3.

With such rotational speed regimen, however, the intensities of turbulence, shear force and cavitation are penalized because they are too high and cannot be modulated downwards; the power consumption absorbed by the motor moving the movable members of the motor-driven treatment assembly and hence the operating costs are also penalized.

iii. Preferably, in order to improve the convenience of industrial implementation, the inclination angle of the protrusions of the movable and fixed members relative to the rotation axis of the movable members must be within the range 3°<α<80°. Within this range, the range 5°<α<60° is the range that allows maximum operating flexibility for the treatment assembly and is thus the preferred range. Even more preferred as range of optimal inclination angles is the range 10°<α<45°.

The inclination of the radial protrusions of the fixed and movable members relative to the rotation axis of the treatment assembly generates a propelling effect in the direction of advancement of the solid phase, i.e., of the substance to be treated, which effect also generates a counterthrust on the liquid phase advancing in countercurrent. Thanks to this phenomenon, a tendency to an increase in the pressure inside the treatment assembly as well as an increase in the prevalence required for the pump feeding the liquid phase to the apparatus are thus obtained.

To avoid this phenomenon, the clearance between rotary member and fixed member must determine a cross-section on a plane perpendicular to the rotation axis of the movable member such that the average speed of advancement of the liquid phase (i.e., the “mean liquid phase cross sectional velocity”) is <1 m/s; and preferably <0.1 m/s.

To prevent generation of uncontrolled local turbulent phenomena, it is also preferable that the inclination of the protrusions of the fixed members and the inclination of the protrusions of the movable members are selected so as to be the same.

By identifying with the dimensionless Froude number the parameter of characterization of the operational regimen of the treatment assembly or solid-liquid contactor, where the Froude number is defined as follows:

$$Froude number , Fr = w 2 R / g$$

where:
w: angular velocity of rotation of the rotor(s) [rad/s]
g: gravity acceleration=9.806 [m/s]
R: outer radius of the rotor [m]
   and by identifying with α the inclination angle of the protrusions of the fixed and movable members relative to the rotation axis of the contactor, the following inter-propulsion index (TPI) has been defined:

$$TPI = Log ( Fr ) \times Cos ( α )$$

where:
Log(Fr): is the 10 based logarithm of the Froude number;
Cos(α): is the cosine of the inclination angle α of the radial protrusions, or teeth, of the fixed members, or stators, and of the movable members, or rotors, i.e., of the stator and rotor teeth relative to the rotation axis S1 of the rotors.

In order for the solid-liquid contactor to be operatable in a stable countercurrent mode throughout the range of L/S ratios of industrial interest, i.e., 0.2<(L/S)<100, the inclination of the rotor-stator teeth as well as the configuration of the contactor and the operating regimen thereof must be such as to fulfil the ratio:

$$0.1 < TPI < 4.$$

In a preferred embodiment of the invention, the rotor and stator teeth and rectilinear inclined teeth.

According to the invention, the propelling effect in the direction of advancement of the solid phase can also be obtained with other configurations of teeth, for example parabolic or sigma-shaped configurations.

FIG. 2 shows an example of parabolic teeth, where:
α: trailing angle=angle of propelling inclination corresponding to the angle of actual inclination of the teeth and to the angle to be used when assessing TPI;
β: leading angle.

α≥0 e β≥0 applies to this configuration, and α=300 and β=0° applies to the illustrated example.

FIG. 3 shows an example of “sigma-shaped” teeth, where:
α: trailing angle=angle of propelling inclination corresponding to the angle of actual inclination of the teeth and to the angle to be used when assessing TPI;
β: leading angle.

α=≥0 e β≥0 applies to this configuration, and α=β=45° applies to the illustrated example.

According to the invention, at least one of the protrusions of the first fixed members and/or of the first movable members is configured so as to cause, during rotation of the movable member, a propelling effect over the flow of substance to be treated, in a direction substantially contrary to the counterflow of extracting substance.

According to the invention, said at least one propelling radial protrusion comprises a propelling surface inclined relative to the rotation axis of the rotary member.

Still according to the invention, said surface faces downstream of the fixed or rotary member, respectively, in the direction of travel through the cavitation stage of the flow of substance to be treated.

Still according to the invention, said at least one propelling radial protrusion comprises a propelling surface the projection of which on a plane perpendicular to the rotation axis of the movable member determines, on said plane, a surface having a non-null area.

More particularly, said at least one propelling radial protrusion comprises a surface the projection of which on a plane perpendicular to the rotation axis of the rotary member and located downstream of the rotary member in the direction of travel of the flow of substance to be treated determines, on said plane, a surface having a non-null area.

In addition, the motor-driven treatment assembly is preferably arranged so as to cause passage of said flows inside the apparatus in substantially parallel but substantially opposite directions.

The motor-driven treatment assembly is capable of rotating the movable members with a velocity suitable to cause the phenomena of cavitation and mixing inside the assembly. Said velocity can indicatively be between 500 and 5000 rpm and is more preferably between 700 and 3000 rpm.

The rotation of the movable members of the motor-driven assembly can be imparted, for example, by an electric gearmotor.

To ensure a proper effect of cavitation on the mixture of substances passing through the motor-driven treatment assembly, the facing surfaces of the protrusions of the rotary member and fixed member further have, preferably, a parabolic contour.

Even more preferably, the protrusions of the rotary member have a parabolic contour in the circumferential direction. In addition, the parabolic contour of said protrusions preferably lies along the curve of a parabola the vertex of which is located at the rear edge of the protrusion, relative to the direction of rotation of the movable member, and along the radius connecting said edge to the center of the movable member or of the fixed member, respectively, the focus of the parabola also lying on said radius.

According to this preferred embodiment of the invention, the protrusions of the rotary member and the fixed member are made with an identical, specular parabolic contour.

The equation of the preferred parabola for the contour of the protrusions of the fixed member and the movable member is expressed by the function Y=0.0062974·X2.

Between the protrusions of the fixed and movable members there is provided a clearance that is minimum at the rear edges of the teeth of the movable and fixed members, when said edges lie substantially aligned along the corresponding radiuses of the movable and fixed members.

Advantageously, according to a preferred embodiment of the invention, the motor-driven treatment assembly is provided with at least one second fixed member and at least one corresponding second movable member, rotary relative to the fixed member. Said second fixed member and said second movable member cooperate with each other to define a corresponding mixing stage in order to promote mixing of said substances passing in opposite directions within the motor-driven treatment assembly.

In a preferred embodiment of the invention, the apparatus comprises a housing that houses the motor-driven treatment assembly. The first fixed member of the motor-driven treatment assembly and the second fixed member of the motor-driven treatment assembly are also preferably integral with the housing and can possibly be made as a single piece with said housing, thereby giving the fixed members of the motor-driven treatment assembly a substantially monolithic configuration.

In a particular embodiment of the invention, the apparatus comprises a motor-driven treatment assembly provided with a plurality of cavitation stages and a plurality of mixing stages, alternating with each other and organized so as to be passed through in succession by said flow of substance to be treated and said counterflow of extracting substance in substantially parallel but substantially opposite directions.

Preferably, the first fixed members further comprise corresponding first cylindrical stator rings provided with radial protrusions, and the first rotary members comprise a plurality of rotor discs provided with radial protrusions and surrounded by said first stator rings. Sid first stator rings define a corresponding cavitation chamber in which said first rotary members operate. According to the invention, at least part of said radial protrusions are propelling radial protrusions.

The second fixed members comprise corresponding second cylindrical stator rings, and said second rotary members comprise a plurality of radial protrusions and are surrounded by said second stator rings. Said second stator rings define a corresponding mixing chamber in which said second rotary members operate.

According to a preferred embodiment of the invention, said radial protrusions of the second rotary members comprise corresponding cylindrical pins or pegs, capable of giving the mixture of encountered substances a high-turbulence regimen, during rotation of the movable members.

According to the invention, preferably, said mixing stage is capable of subjecting the multiphase flow to a high-turbulence regimen with Re>500000.

Preferably, the cylindrical pins extend radially from the rotation axis of the second movable members over a length such that the diameter of the outer circumference described by the pin is in the range 0.3-0.9×D, where D is the mixing chamber inner diameter defined by the inner wall of the second fixed members or second stator rings.

Furthermore, preferably, said pins are at least two, or even more preferably three, in number and are arranged on parallel, preferably non-coincident planes perpendicular to the rotation axis of the second rotary member.

Preferably, all the movable members are rotationally fixed to a single motor-driven common rotary shaft.

In an exemplary embodiment of the invention, the motor-driven treatment assembly comprises three cavitation stages and four mixing stages. Still according to this embodiment of the invention, the flow of substance to be treated passes in a first direction and sequentially through the following: a first mixing stage, a first cavitation stage, a second mixing stage, a second cavitation stage, a third mixing stage, a third cavitation stage and a fourth mixing stage. The counterflow of extracting substance passes through said stages sequentially in a second direction, opposite to the first direction: a fourth mixing stage, a third cavitation stage, a third mixing stage, a second cavitation stage, a second mixing stage, a first cavitation stage and a first mixing stage.

The motor-driven treatment assembly is provided with an inlet port for the substance to be treated and an outlet port for the spent substance to be treated, and an inlet port for the extracting substance and an outlet port for the extracted substance.

Preferably, the inlet port for the substance to be treated and the outlet port for the extracted substance are arranged in the first mixing stage, whereas the inlet port for the extracting substance and the outlet port for the spent substance to be treated are arranged in the last mixing stage.

In a form of usage typical of the apparatus according to the invention, the substance to be treated arrives at the inlet port in the solid or fluid state containing a solid part, in the form of powder, crushed pieces, sludge and flakes, and the spent substance to be treated arrives at the outlet port in the form of a substantially squeezed solid residue. Still referring to this form of usage of the apparatus, the extracting substance and the extracted substance arrive in the liquid form.

According to the invention, the extracting liquid phase can also be fed through lateral nozzles through the stator wall at the high-turbulence mixing sections, thereby causing a current of extracting substance, which typically is at the liquid state, given by the combination of the flows of extracting substance coming from the corresponding inlet port and the lateral nozzles.

### DESCRIPTION OF THE FIGURES

Some preferred embodiments of the invention will be provided by way of non-limiting examples with reference to the annexed figures, in which:

FIG. 1 is an example of rectilinear inclined teeth;

FIG. 2 is an example of parabolic inclined teeth;

FIG. 3 is an example of sigma-shaped inclined teeth;

FIG. 4 is a partially cut perspective view of an apparatus according to the invention;

FIG. 5 is a schematic sectional view along a longitudinal plane of the apparatus of FIG. 1;

FIG. 6 is a perspective view of the rotary part of the treatment assembly of the apparatus of FIG. 1;

FIG. 7 is a plan view of a fixed part of the treatment assembly of the apparatus of FIG. 1.

### DESCRIPTION OF SOME PREFERRED EMBODIMENTS OF THE INVENTION

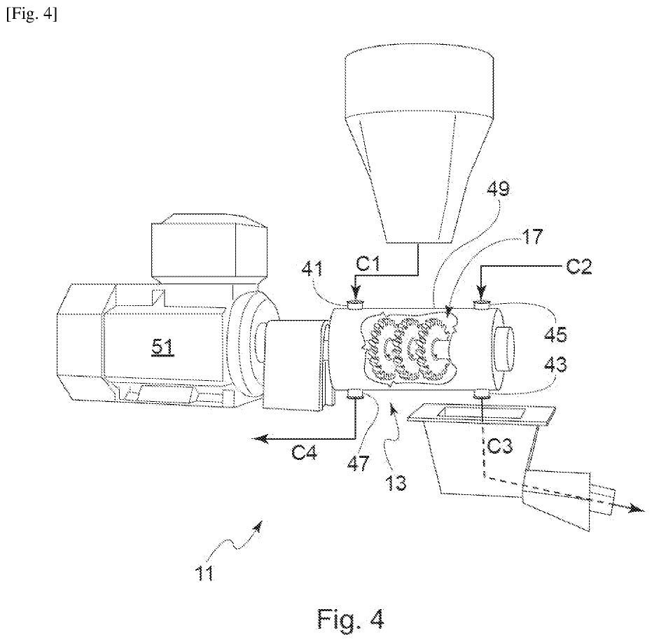

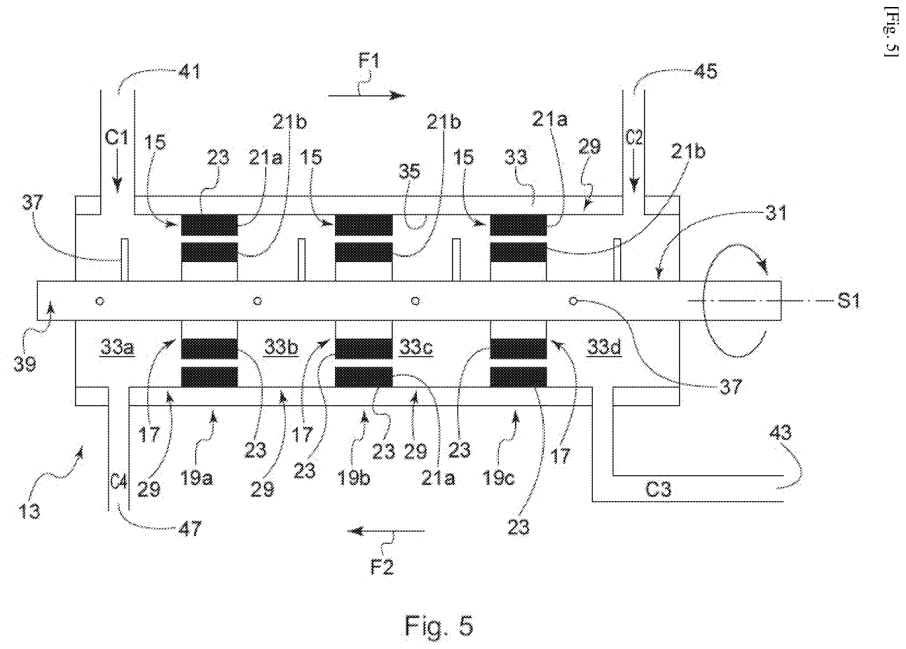

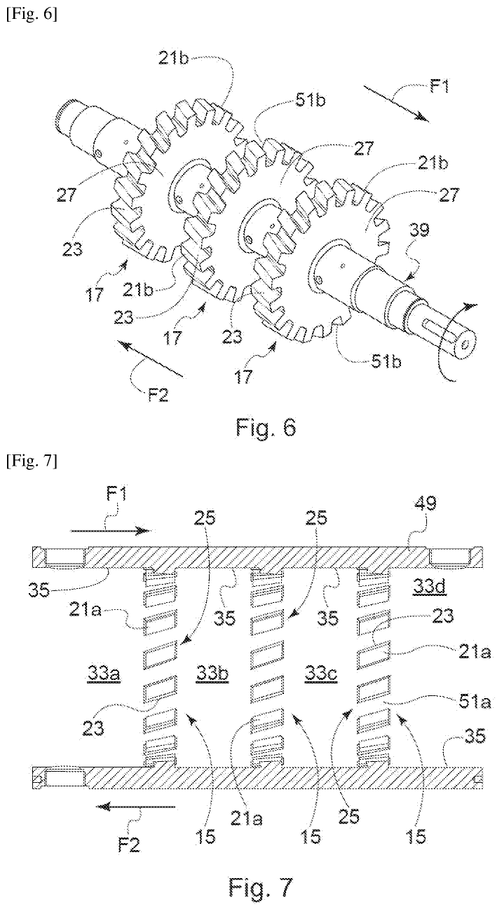

Referring to FIGS. 4 to 7, there is illustrated an apparatus 11 for treating a flow or current of a substance to be treated C1 by means of a counterflow or countercurrent of an extracting substance C2, made in accordance with a preferred embodiment of the invention.

In the illustrated embodiment, the apparatus 11 comprises a motor-driven treatment assembly 13 in which a flow of substance to be treated C1 and a counterflow of extracting substance C2 pass along substantially parallel but substantially opposite directions shown in the figure with arrows F1 and F2, respectively.

Still referring to the illustrated embodiment, in the motor-driven treatment assembly 13 there are provided three first fixed members 15 and three corresponding first movable members 17. The movable members 17 rotate about a rotation axis S1 relative to the fixed members 15 and cooperate therewith to define corresponding cavitation stages 19a,19b,19c capable of causing the phenomenon of hydrodynamic cavitation in a mixture of substances passing in opposite directions inside the motor-driven treatment assembly 13.

According to the invention, the first fixed members 15 and the first movable members 17 are provided with a plurality of radial protrusions 21a,21b, configured so as to cause, during rotation of the movable member 17 about the axis S1, a propelling effect on the flow of substance to be treated, in a direction F1 substantially opposite to the counterflow F2 of extracting substance.

The propelling radial protrusions 21a,21b comprise a propelling surface 23, inclined relative to the rotation axis S1 of the first movable member 17.

The first fixed members 15 comprise corresponding first cylindrical stator rings 25 provided with propelling radial protrusions 21a and the first rotary members 17 comprise corresponding rotor discs 27 provided with propelling radial protrusions 21b and surrounded by said stator rings 25.

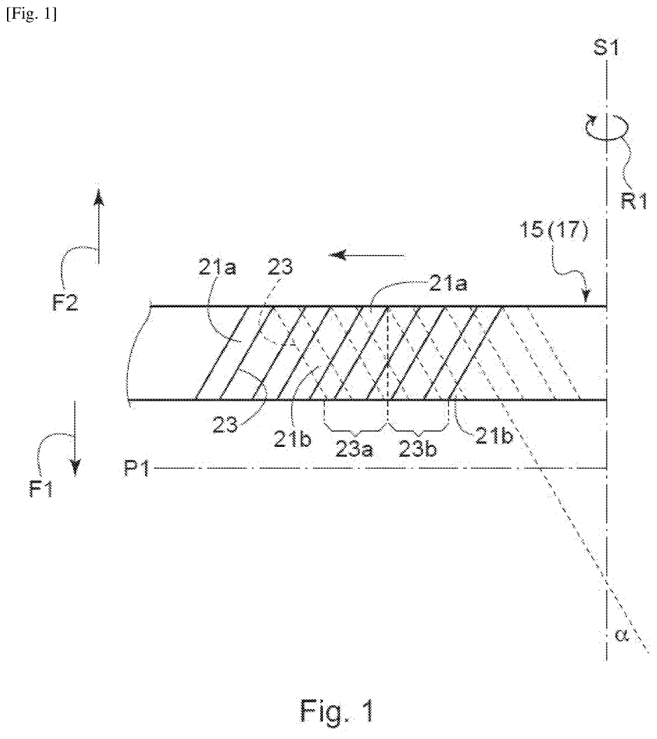

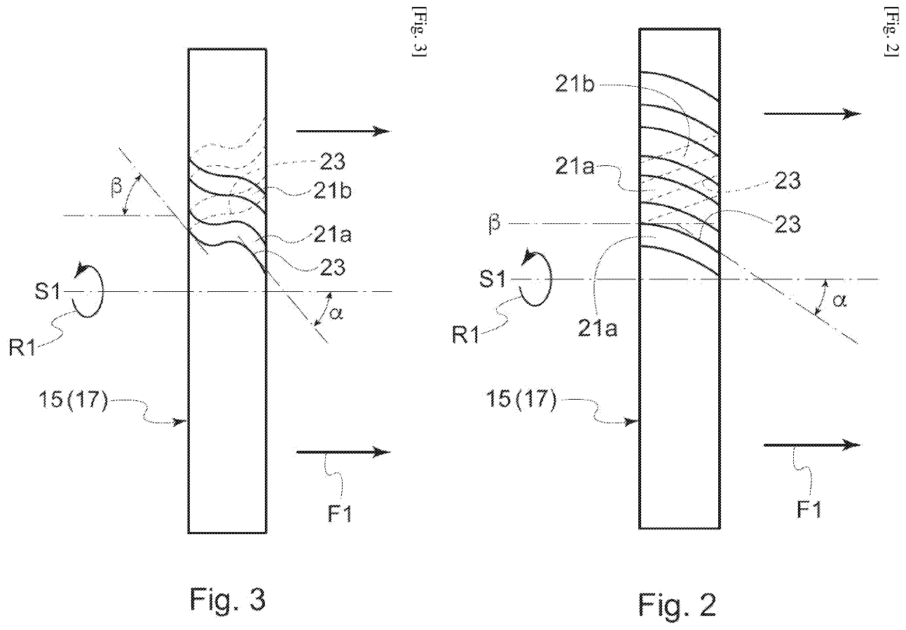

As shown in FIG. 1, the propelling surface 23 of the first fixed member 15 and of the first movable member 17 is such that the projection of said surface on a plane P1, perpendicular to the rotation axis S1 and located downstream of the propelling surface 23 in the traveling direction F1 of the substance to be treated, determines on said plane P1 a respective surface 23a, 23b having a non-null area.

Referring again to FIGS. 4 to 7, the motor-driven treatment assembly 13 is provided with four second fixed members 29 and four second movable members 31. The movable members 31 rotate about the axis S1 relative to the fixed members 29 and cooperate therewith to define corresponding stages of turbulent mixing 33a,33b,33c,33d to promote mixing of the substances passing in opposite directions inside the motor-driven treatment assembly 13.

The second fixed members 29 comprise corresponding second cylindrical stator rings 35, and the second movable members 31 comprise a plurality of second radial protrusions 37 and are surrounded by said second stator rings 35.

In the illustrated embodiment, the second radial protrusions 37 comprise corresponding rectilinear cylindrical pins or pegs.

In the illustrated embodiment of the invention, the motor-driven treatment assembly 13 comprises altogether three cavitation stages 19 and four mixing stages 33.

In the illustrated exemplary configuration, the cavitation stages 19 and the mixing stages 33 alternate with each other and are organized so as to be passed through in succession by the flow of substance to be treated in a first direction F1 and said counterflow of extracting substance in a second, opposite direction F2, in substantially parallel directions.

Still referring to the illustrated embodiment, all the movable members 17, 31 are rotationally fixed to a single motor-driven common rotary shaft 39.

Other embodiments of the invention will be conceivable in which the cavitation stages and mixing stages can be any in number and variously organized.

The motor-driven treatment assembly 13 is provided with inlet and outlet ports for the substances passing therethrough. In the illustrated embodiment, the assembly 13 is provided with an inlet port 41 for the substance to be treated C1 and with an outlet port 43 for the spent substance to be treated C3, with an inlet port 45 for the extracting substance C2 and with an outlet port 47 for the extracted substance C4.

Still referring to the illustrated embodiment, the apparatus 11 comprises a housing 49, the fixed members of the cavitation stages 19 and of the mixing stage 33 being integral with said housing. Said first fixed members 15 and said second fixed members 29 are also made as a single piece with the housing 49. The shaft 39 is connected to a gearmotor 51 capable of rotating the movable members 17 and 31 of the motor-driven treatment assembly 13.

In the illustrated embodiment, the adjacent first radial protrusions 21a,21b comprise parallel, inclined, facing surfaces 23, which define corresponding inclined grooves or channels 51a, 51b for the passage of said substances during rotation of the first movable members 17.

### EXAMPLE

Solid-liquid extraction tests were carried out on solid phases consisting of plant matrices (both in the form of powder with a particle size between 50 and 250 microns and in the form of crushed leaves, or ‘tea-cut’ with a particle size between 0.5 and 2.5 mm), by using water as extracting liquid and by feeding the phases in countercurrent on an apparatus 11 according to the described exemplary embodiment of the invention, with the following features:
N^{o} of stages of turbulent mixing 33: four;
N^{o} of high-shear-force and cavitation stages 19: three (first fixed members and first movable members being all provided with propelling protrusions, i.e., protrusions defining inclined surfaces 23 capable of causing, during rotation of the movable member 17, a propelling effect on the flow of substance to be treated);
Stages of turbulent mixing 33 alternating with high-shear-force and cavitation stages 19;
Inner diameter of the stages of turbulent mixing 33: 206 mm;
Axial length of the stages of turbulent mixing 33: 80 mm;
Pegs 37 of the mixing stage: six pegs arranged on parallel planes perpendicular to the rotation axis S1 of the motor-driven treatment assembly, so as to form a spiral with a forward thrust when the shaft 39 rotates. The circumference described by the pegs 37 during rotation is 0.9×D, where D=inner diameter of the mixing stages 33;
Inner radius of the cavitation stages 19: 96 mm;
Minimum rotor-stator clearance of the cavitation stages 19: 3 mm (first stage 19a), 2.2 mm (second stage 19b) and 1.5 mm (third stage 19c);
Axial length of the first stator rings 25 and rotor discs 27 of the cavitation stages: 30 mm;
Rotational speed of the shaft 39: in the range 500-2500 rpm;
Number of stator grooves 51a: 18;
Number of rotor grooves 51b: 18;
Stator teeth 21a: rectilinear with inclination a of 180 relative to the rotation axis S1 of the apparatus.
Rotor teeth 21b: rectilinear with inclination a of 18° relative to the rotation axis S1 of the apparatus.

With this configuration it is possible to obtain a flow of the solid phase in countercurrent relative to the liquid phase and stable throughout the tested range of rotational speeds (i.e., 500-2500 rpm, corresponding to the range of TPI between 1.35 and 2.68) and up to ratios L/S=0.2.

The invention as described and illustrated is susceptible to numerous alternatives and modifications, falling within the same inventive principle.

1: An apparatus (11) for treating a flow of a substance to be treated by means of a counterflow of an extracting substance, said apparatus comprising a motor-driven treatment assembly (13) in which said flows pass in substantially opposite directions (F1,F2) and in which there are defined at least one first fixed member (15) and at least one corresponding first movable member (17) rotary relative to the fixed member and cooperating therewith to define a corresponding cavitation stage (19) capable of causing the phenomenon of hydrodynamic cavitation in a mixture of said substances, characterized in that said at least one fixed member (15) and/or said at least one movable member (17) is provided with a plurality of radial protrusions (21a,21b), at least one of which is configured so as to cause, during rotation of the movable member (17), a propelling effect over the flow of substance to be treated, in a direction (F1) substantially opposite to the counterflow (F2) of extracting substance, wherein said at least one propelling radial protrusion (21a,21b) comprises a propelling surface (23) the projection of which on a plane (P1) perpendicular to the rotation axis of the movable member (17) determines, on said plane, a surface (23a,23b) having a non-null area.

2. (canceled)

3: The apparatus according to claim 1, wherein said at least one propelling radial protrusion (21a,21b) comprises a propelling surface (23) inclined relative to the rotation axis (S1) of the movable member (17).

4: The apparatus according to claim 3, wherein the motor-driven treatment assembly (13) is provided with at least one corresponding second fixed member (29) and at least one second movable member (31) rotary relative to the fixed member and cooperating therewith to define a corresponding stage of turbulent mixing (33) to promote mixing of said substances passing in opposite directions inside the motor-driven treatment assembly.

5: The apparatus according to claim 4, wherein the motor-driven treatment assembly (13) comprises a plurality of cavitation stages (19) and a plurality of mixing stages (33), alternating with each other and organized so as to be passed through in succession by said flow of substance to be treated and said counterflow of extracting substance in substantially parallel but substantially opposite directions.

6: The apparatus according to claim 5, wherein said first fixed members (15) comprise corresponding first cylindrical stator rings (25) provided with radial protrusions (21a), and wherein said first rotary members (17) comprise corresponding rotor discs (27) provided with radial protrusions (21b) and surrounded by said first stator rings, and wherein said radial protrusions (21a,21b) are propelling radial protrusions.

7: The apparatus according to claim 1, wherein said at least one propelling radial protrusion (21a, 21b) has a rectilinear or parabolic or sigma-shaped inclined configuration.

8: The apparatus according to claim 5, wherein said second fixed members (29) comprise corresponding second cylindrical stator rings (35), and wherein said second rotary members (31) comprise a plurality of radial protrusions (37) and are surrounded by said second stator rings, and wherein said radial protrusions comprise corresponding cylindrical pins.

9: The apparatus according to claim 1, wherein adjacent radial protrusions (21a,21b) comprise mutually facing parallel inclined surfaces (23) defining corresponding inclined grooves or channels (51a,51b) for the passage of said substances.

10: A method for treating a flow of a substance to be treated by means of a counterflow of an extracting substance, said method comprising the steps of:
arranging a motor-driven treatment assembly (13) comprising at least one first fixed member (15) and at least one corresponding first movable member (17) rotary relative to the fixed member and cooperating therewith to define a corresponding cavitation stage (19) capable of causing the phenomenon of hydrodynamic cavitation in a mixture of said substances, said at least one fixed member (15) and/or said at least one movable member (17) being provided with a plurality of radial protrusions (21a,21b);
causing passage of said flows within said motor-driven treatment assembly (13) in substantially parallel but substantially opposite directions;
promoting, during rotation of the first movable member, a propelling effect over the flow of substance to be treated, in a direction (F1) substantially opposite to the counterflow (F2) of extracting substance, by means of at least one of said radial protrusions (21a,21b); and
causing, in said substances, a turbulent mixing upstream and downstream of the cavitation stage (19);
wherein said propelling radial protrusions (21a,21b) comprise a propelling surface (23) the projection of which on a plane (P1) perpendicular to the rotation axis of the movable member (17) determines, on said plane, a surface (23a,23b) having a non-null area.

11-12. (canceled)

13: The method according to claim 10, wherein said radial protrusions (21a, 21b) are propelling radial protrusions and comprise a propelling surface (23) inclined relative to the rotation axis (S1) of the movable member (17).
